(19) United States
(12) Patent Application Publication
(10) Pub. No.: US 2019/0305927 A1
(43) Pub. Date: Oct. 3, 2019

(54) BITSTREAM SECURITY BASED ON NODE LOCKING

(71) Applicant: University of Florida Research Foundation Incorporated, Gainesville, FL (US)

(72) Inventors: Swarup Bhunia, Gainesville, FL (US); Robert A. Karam, Gainesville, FL (US); Tamzidul Hoque, Gainesville, FL (US)

(21) Appl. No.: 16/081,027

(22) PCT Filed: Mar. 17, 2017
(86) PCT No.: PCT/US2017/023017

§ 371 Date: Aug. 29, 2018

Related U.S. Application Data
(60) Provisional application No. 62/310,543, filed on Mar. 18, 2016.

(51) Int. Cl. H04L 9/00; H03K 19/177; G06F 21/44; G06F 21/76; H04L 29/06; H04L 9/08

(52) U.S. Cl. CPC H04L 9/002; H03K 19/17768; G06F 21/44; H04L 2209/16; H04L 63/0457; H04L 9/0866; G06F 21/76

(57) ABSTRACT

A technique to generate node locked bitstreams for FPGAs to simultaneously protect against malicious reconfiguration as well as FPGA IP piracy is provided. According to some aspects, modifications in FPGA architecture along with an associated mapping flow enable authenticating and programming a device in a way that maintains FPGA security while requiring low overhead. The technique is more robust against side channel and destructive reverse-engineering attacks in comparison with key-based encryption methods, and has less area, power, and latency overhead. The node locked bitstream approach is attractive in many existing and emerging applications including IoTs, which may require field upgrade of FPGA.

### RELATED APPLICATIONS

This application claims priority to and the benefit of U.S. Provisional Patent Application No. 62/310,543, entitled “BITSTREAM SECURITY BASED ON NODE LOCKING,” filed Mar. 18, 2016. The entire contents of the foregoing are hereby incorporated herein by reference.

### BACKGROUND OF INVENTION

Embedded and wearable computing devices have proliferated in recent years in a large diversity of form factors, performing cooperative computation to provide the new regime of Internet-of-Things (IoT). This proliferation trend is expected to continue, with an estimated 50 billion smart, connected devices by 2020. A key feature in such devices is the need for in-field reconfigurability to adapt to changing requirements in energy-efficiency, functionality, and security. Field Programmable Gate Arrays (FPGAs) have emerged as a popular architecture for addressing this reconfigurability demand. FPGAs provide a high flexibility compared to custom Application-Specific Integrated Circuit (ASIC), while consuming less energy than designs based on firmware running in microcontrollers. Furthermore, FPGA-based designs are known to be more secure than both ASIC and microcontrollers against supply-chain attacks, e.g., design details are not exposed to foundries or entrusted outsourcing.

Bitstreams contain configuration information for programming a programmable device, such as an FPGA. FPGA bitstreams are susceptible to a variety of attacks, including unauthorized reprogramming, reverse-engineering, and cloning/piracy. Therefore there is a need to provide protection of FPGA bitstreams, both during wireless reconfiguration and after in-field deployment in FPGA-based designs.

### BRIEF SUMMARY

Disclosed herein is an approach to FPGA security that provides protection against in-field bitstream reprogramming as well as Intellectual Property (IP) piracy, while permitting wireless reconfiguration without encryption.

The inventors have recognized and appreciated that traditional countermeasures against FPGA bitstream attacks, such as shielding, noise injection, etc., use more energy than desired for most modern embedded and IoT devices that have aggressive energy constraints. The present disclosure details aspects of an approach to FPGA security, which can prevent unauthorized in-field reprogramming as well as FPGA IP piracy without encryption. In some embodiments, a node-locked bitstream approach, where the device-to-bitstream association is changed from device to device, is employed.

According to some embodiments, a programmable device is provided. The programmable device may include an external interface, a first circuit configured to generate an identifier and a second circuit configured to transmit through the external interface at least one response to one or more messages received through the external interface. At least a portion of the at least one response may be based at least in part on the identifier. The programmable device may further include a third circuit configured to perform a de-obfuscating function on a bitstream. The de-obfuscating function may be based at least in part on the identifier. According to some embodiments, the programmable device may be a field programmable gate array (FPGA). The at least a portion of the identifier generated by the first circuit may be based on a plurality of selectively blown fuses in the programmable device. At least a portion of the identifier may have a value that varies over time. The third circuit may include at least one sub-circuit configured to selectively permutate the bitstream such that a position within the bitstream of at least a portion of the bitstream is changed based at least in part on the identifier. The third circuit may include a plurality of sub-circuits, connected in series, wherein each of the plurality of sub-circuits is configured to selectively permutate the bitstream such that a position within the bitstream of at least a portion of the bitstream is changed based at least in part on the identifier.

According to some embodiments, a method of securely programming a programmable device is provided. The method may include obtaining an identifier from the programmable device; obfuscating a bitstream based at least in part on the identifier; and sending the obfuscated bitstream to the programmable device. Obtaining the identifier may include sending a sequence of challenges to the programmable device; receiving a sequence of responses to the sequence of challenges from the programmable device; and determining, based on the sequence of responses, the identifier for the programmable device. The method of securely programming a programmable device may further include authenticating the programmable device based on the identifier in relation with an authorized identifier list. Authenticating the programmable device based on the identifier in relation with an authorized identifier list may include obtaining the authorized identifier list from an external source. Obtaining the authorized identifier list from an external source may include communicating with the external source using secure communications. Obfuscating the bitstream may include permutating the bitstream. Obfuscating the bitstream may also include iteratively permutating the bitstream such that a position within the bitstream of at least a portion of the bitstream is changed based at least in part on the identifier. Obfuscating the bitstream further may include generating a key based on the identifier and obfuscating the bitstream by performing a plurality of obfuscation functions. Each of the plurality of obfuscation functions may be based on the key. Performing a plurality of obfuscation functions may include iteratively permutating the bitstream such that a position within the bitstream of at least a portion of the bitstream is changed based at least in part on the key. Obfuscating the bitstream based on the at least one identifier may include applying a plurality of permutation levels. The plurality of permutation levels may have a first level, a second level and a third level. The first level may include permutation of portions of the bitstream that specify an input ordering of a look up table (LUT); the second level may include permutation of the portion of the bitstream that specifies a content of the LUT and the third level may include a block based permutation of the entire bitstream.

According to some embodiments, a method of securely operating a programmable device that receives a programming bitstream is provided. The method may include generating a pseudo-random identifier and transmitting a sequence of responses based on the identifier in response to receiving a sequence of challenges. At least a portion of the sequence of responses may be based at least in part on the identifier. The method may also include deobfuscating a received bitstream based on the identifier; and programming programmable circuitry within the programmable device based on the de-obfuscated bitstream. De-obfuscating the bitstream based on the identifier may include permutating the bitstream based on the identifier. De-obfuscating the bitstream based on the identifier may include transforming the bitstream based on a plurality of fuses in the programmable device that are selectively blown. De-obfuscating the bitstream based on the identifier may further include applying a plurality of permutation levels. The plurality of permutation levels further may include a first de-obfuscation level, a second de-obfuscation level and a third de-obfuscation level. The first de-obfuscation level may include permutating the bitstream on a first portion of the programmable device; the second de-obfuscation level may include permutating the bitstream on a second portion of the programmable device; the third de-obfuscation level may include permutating the bitstream on a third portion of the programmable device.

The foregoing is a non-limiting summary of the invention, which is defined by the appended claims.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures may be represented by a like numeral. For purposes of clarity, not every component may be labeled in every drawing.

FIG. 1 is a schematic diagram for an exemplary flow for FPGA bitstream encryption and authentication;

FIG. 2 is a schematic diagram for an exemplary Challenge/Response-based Communication Protocol (CRCP) in some embodiments;

FIG. 3a is a schematic diagram showing an exemplary system flow when the Challenge/Response Communication Protocol (CRCP) identifies and authenticates a device in some embodiments;

FIG. 3b is a schematic diagram showing an exemplary system flow of the node locked bitstream approach in some embodiments;

FIG. 4 is a schematic diagram of an exemplary mapping flow in some embodiments;

FIG. 5a is a schematic diagram showing an exemplary bitstream transform key generation process, according to some embodiments;

FIG. 5b is a schematic diagram for an exemplary three level transformation scheme;

FIG. 6a is a schematic diagram for an exemplary three level transformation scheme showing three levels of transformation by the Vendor tool and three levels of inverse-transformation in the FPGA;

FIG. 6b is a schematic diagram showing an exemplary inverse transformation in some embodiments;

FIG. 6c is a schematic diagram for an example Level 1 inverse transform network operating on 16 bits of input, using 4 bits of key to transform data;

FIG. 7 is a schematic diagram showing a simplified exemplary architecture of an FPGA fabric containing CLBs, Block RAMs, DSP blocks, routing resources, and IO Blocks in some embodiments;

FIG. 8 is a schematic diagram of an example LUT structure containing SRAM cell and MUX with peripheral logics such as Flip Flops and MUX according to one embodiment. Various inversion and transformation logic is applied to implement permutation and selective inversion based security;

FIG. 9 is a schematic diagram showing an example of routing resources such as a switch box and gate level design of switch points;

FIG. 10 is a schematic diagram showing an exemplary structure of a bitstream frame containing bits for JOB, CLB, BRAM, DSP, and their interconnects according to prior art [Ref. 19]. A single frame may represent a tiny portion of the physical FPGA layout. The whole design may be implemented through a large number of such frames;

FIG. 11 is a schematic diagram of an exemplary protocol for PUF-based application security using a trusted cloud server;

FIG. 12 is a schematic diagram showing an exemplary scheme of key-based bitstream obfuscation;

FIG. 13 is a schematic diagram showing an exemplary security-aware mapping for FPGA bitstreams;

FIG. 14 is a schematic flow diagram of an exemplary software flow leveraging FPGA dark silicon for design security through key-based obfuscation.

### DETAILED DESCRIPTION OF INVENTION

The inventors have recognized and appreciated security techniques for programmable devices that ameliorate limitations of existing security techniques, improving the usefulness of programmable devices for low cost, widely used devices, such as those that can be used to implement the IoT. For example, on-board encryption technologies used in modern FPGA-based devices incur large area and power overhead, particularly for area/energy-constrained applications. Furthermore, since the attacker typically has physical access to the device, most on-board encryption techniques are susceptible to side-channel attacks, e.g., by key extraction through power profile signatures [Ref. 1]. Moreover, they are still vulnerable to piracy and malicious alteration during in-field upgrade.

Therefore, there exists a need for a secure programmable device and programming method to safeguard against bitstream attacks, without incurring large area and energy overhead. Techniques that provide one or more of these characteristics are described herein. The inventors have recognized that two primary attack models exist for programmable devices: unauthorized reprogramming and reverse engineering. Unauthorized reprogramming using a bitstream maliciously modified by insertion of a Trojan may alter system functionality, leak information, or cause a failure. A reverse-engineered design can be sold as original, leading to Intellectual Property (IP) piracy.

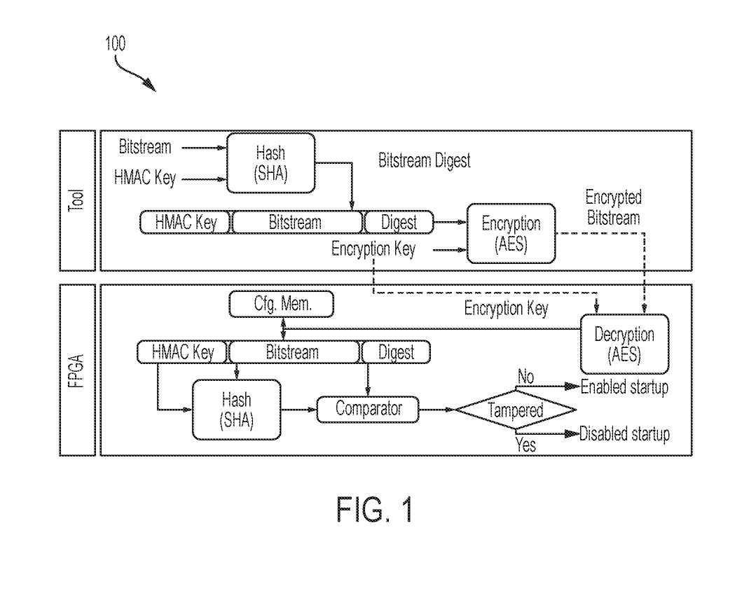

To combat unauthorized reprogramming in the first attack model, the inventors have recognized that bitstream encryption may be used. FIG. 1 shows an example of such an encryption process 100. Bitstream encryption using a symmetric cypher such as Triple DES (3DES) or AES, is typically used for protecting the configuration files in the bitstream. An decryption engine inside the FPGA is used to decrypt the configuration bits before it is mapped to FPGA resources. In many cases, these keys are generated by a vendor's mapping tool and are transmitted along with the bitstream itself. If transmitted over a network, this can greatly compromise system security.

The use of FPGA-specific keys has also been investigated. For example, a public key cryptography scheme which uses a trusted third party for key transportation and installation has been proposed [Ref. 2]. However, this scheme relies on the assumption that the FPGA has built-in fault tolerance and tamper resistance countermeasures, including multiple instances of identical cryptographic blocks for detecting operational faults, which would not be viable for area- and power-limited systems.

FPGAs like the Xilinx Zynq-7000 [Ref. 3] integrate an SoC and FPGA in a single system, and use public key cryptography for authentication during a secure boot process. The public key used to decrypt configuration files is stored in the device's nonvolatile memory, and its integrity is checked before every use [Ref. 4]. These security measures rely on a CPU to control the secure boot process, and are therefore viable only in such hybrid systems. A common feature among these encryption-based techniques is that key storage is resilient to physical attacks; however, this feature is often lacking in practice [Ref. 5].

Mathematically, the encryption algorithms are known to be highly secure against brute force attacks. However, successful Side-Channel Attacks (SCA) have been mounted against these systems, enabling decryption of the IP [Refs. 6-8]. The inventors have recognized that unless additional countermeasures are in place (e.g. obfuscation), an adversary can easily convert the bitstream to a netlist [Ref. 9], making malicious modifications possible. Therefore, even state-of-the-art methods for FPGA bitstream encryption cannot ensure IP security.

On the other hand, to counter the second model of bitstream attack such as bitstream tampering, hashed codes are often used as authentication, similar to checksums on software. While this can help prevent malicious modification, it cannot prevent reverse engineering of the IP. This method also provides key storage in nonvolatile memory, for which successful differential power analysis (DPA) attacks have been demonstrated [Ref. 10].

As discussed above, the inventors have recognized that neither encryption nor authentication alone is capable of protecting bitstreams against a motivated attacker. To mitigate this, it is desirable to design an IP protection scheme that has the following properties:

Resilient to brute force, side channel, and destructive reverse engineering attacks;

Independent of non-volatile storage, which is known to be vulnerable;

Economical in terms of production and recurring costs;

Low area and power overhead, and viable for use in IoT and other embedded devices;

Capable of restricting reconfiguration to authorized parties.

The inventors have appreciated and recognized the need to provide bitstream security against both primary bitstream attack modes. An aspect of the present disclosure provides a device and method based on changing the underlying architectural configuration of FPGA from device to device such that a bitstream can only work in a specific FPGA device. In some embodiments, an application mapping tool, such as may be used in initially programming or reprogramming an FPGA, queries a device to learn about its architecture and then generates an appropriate node-locked bitstream (NLB) for a specific device. The query may be clone using a Challenge/Response (CR) device authentication approach. The tool then uses device-specific keys to generate a bitstream. To be effective, the NLB is unique to each device according to aspects of an embodiment. In other words, a bitstream compiled for one device may not physically map the same functions on a second. Furthermore, in some embodiments architectural changes may be achieved post-silicon, making the device and method compatible with existing processes while requesting minor adjustments to software tool flow. In some embodiments, device authentication does not rely on a key stored in a nonvolatile memory (NVM). Rather, in some embodiments, a device may use a pseudo-random function to generate an identifier for itself that may be time varying, but revealed in the CR protocol.

Example embodiments of such a programmable device with protocols for device identification, authentication, reconfiguration and secure transmission of bitstreams to remote devices during field upgrade are discussed in detail below.

Furthermore, details of a security analysis are provided below demonstrating protection in some embodiments against key extraction from a bitstream and bitstream reverse-engineering with significantly decreased area and power overhead compared with area-optimized encryption blocks.

The inventors have recognized that for devices that support in-field upgrades, preventing unauthorized reprogramming of a device and ensuring unauthorized or counterfeit devices do not receive valuable upgrades are important security goals, and additional steps may be taken instead of or in addition to a Challenge Response Communication Protocol (CRCP). In one embodiment, through the use of Challenge/Response (CR)-based device authentication and device-specific keys for IP antipiracy, a solution may be provided to render FPGAs more secure against IP piracy and unauthorized reprogramming. According to an aspect, the authentication protocol involves communication between the FPGA Vendor and the Original Equipment Manufacturer (OEM), which produces the bitstream.

In one non-limiting example, CRCP is an authentication mechanism transmitting through an external interface a sequence of 64 bit Challenges as inputs to a circuit such as a Physically Unclonable Function (PUF) on the FPGA. In some embodiments, the circuit may be a MECCA PUF. Although 64 bit Challenges are used as input, any other suitable bit length may be used as the sequence of Challenges to increase the difficulty for brute force attacks to deduce the sequence. A circuit on the FPGA may be used to generate a sequence of Responses to the sequence of Challenges. The sequence of Responses is unique to the particular device and in some embodiments may be based on a unique identifier to the particular device. The unique identifier may include physical modifications performed by the FPGA manufacturer; the identifier may also include time-variant modifications based on a logical-key as described in further detail in the sections below.

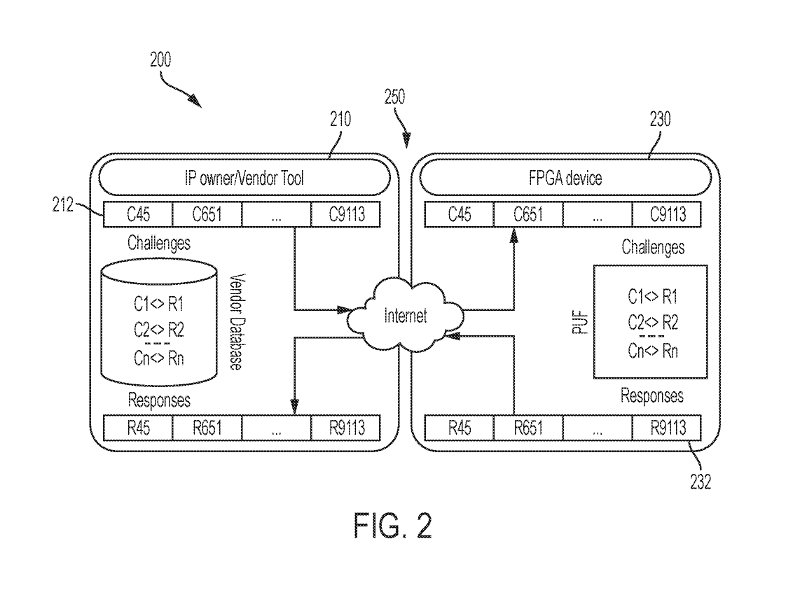

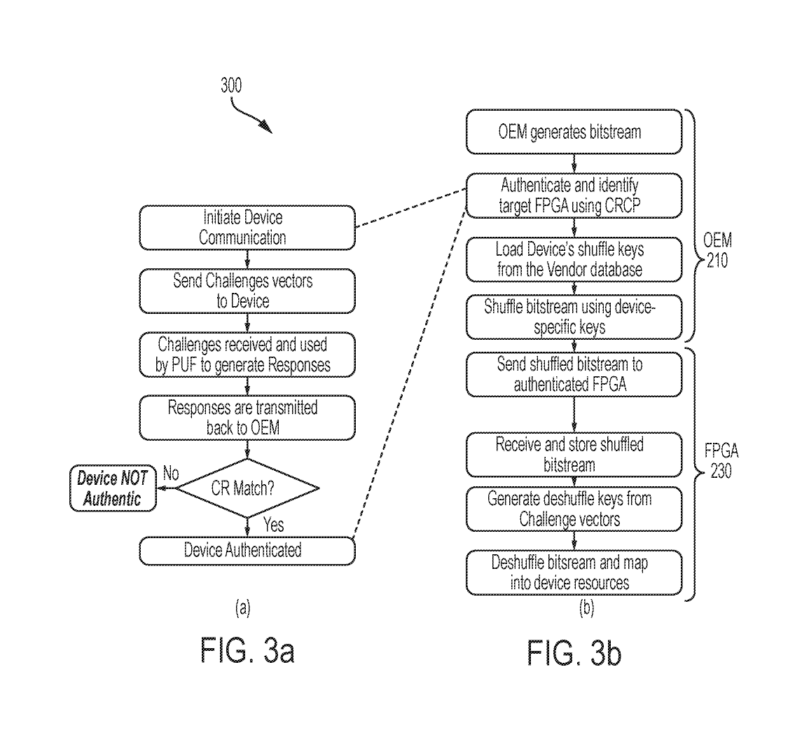

FIG. 2 shows an illustrative example of the CRCP-based authentication process 200, while FIGS. 3a and 3b show another exemplary CRCP-based authentication process 300. To authenticate a device, the OEM 210 sends a predetermined number of challenges 212 through an external interface 250, and the device 230 responds in turn, as shown in the illustrative examples in FIG. 2 and FIG. 3 by transmitting a sequence of responses 232 through the external interface. In some embodiments, the number of challenges may be variable over time. CR pairs may be batched and sent to the Vendor server, which returns a set of device-specific identifiers. In some embodiments, the Vendor/OEM communication may be through secure channels, for example via encrypted communication using industry standard methods. According to one aspect, the authentication scheme may comprise two important components: 1) the Vendor precharacterizes the devices after fabrication through an enrollment process, which ensures that only legitimate devices will receive in-field upgrades; 2) the software tools used by the OEM have access to the Vendor database containing an authorized identifier list.

In some embodiments, once the device has been authenticated, an upgrade procedure using a bitstream may begin. Because the bitstream may be wirelessly transmitted to the device and stored in NVM, it is important to transform it in some way to prevent reverse engineering. According to an aspect of some embodiments, Node Locking a bitstream is provided to an individual FPGA using a two-layer obfuscation scheme which uses both physical and logical key-based architectural modifications to provide a unique identifier to ensure a unique bitstream-to-device mapping. Example techniques to implement the two-layer obfuscation scheme are provided herein.

According to an aspect, the first of two obfuscation layers is based on physical architectural modifications to the underlying FPGA fabric. This layer is comprised of a network of fuses programmed by the FPGA manufacturer after fabrication. The selectively blown fuses may represent a portion of the unique identifier to the FPGA device as manufactured in order to enable bitstream node-locking. In some embodiments, the programming of the network of fuses may be pseudo-random. Devices which do not need reprogramming during their lifetimes (e.g. a printer) may use only the physical obfuscation layer and retain a high degree of security through architectural diversity. Furthermore, in some embodiments because each FPGA is programmed with its vendor's specific toolset, the physical modification may prevent the fabrication facility from overproducing and selling functional devices.

In some embodiments, once the device has been authenticated, the bitstream may be modified by the vendor tool prior to FPGA programming. Based on the configuration of the physical modifications, LUT content bits, programmable interconnect switches, or other configuration bits may be inverted, permuted, or otherwise transformed to fit the target architecture. In some embodiments, no additional hardware cores (e.g. decryption modules) are provided when using just the physical obfuscation layer because these are physical changes made to the FPGA, and the customized bitstream will work only with that particular FPGA. Additionally as will be discussed in relation to some embodiments below, at least one hardware core in the FPGA may be provided in combination with a logical key-based time-variant obfuscation layer.

In some embodiments, logical key-based and time-variant modifications are also made to the architecture. The modifications may be realized through the addition of permutation networks which modify the functions mapped to the FPGA. The time-variant logical-key may represent a portion of the unique identifier to the FPGA device in order to enable bitstream node-locking. In some embodiments, the time-variant logical-key may be pseudo-randomly generated. The time-variant logical-key effectively evolves the architecture of the programmable device with time during, for example, each time a device such as an FPGA is reprogrammed. Similar to physical-obfuscation, the vendor tool may make modifications to the bitstream at the end of the tool flow to implement the time-variant layer of obfuscation. For example, the tool will perform a series of obfuscation functions or transformations (e.g. permutations) on the configuration bits based on the unique logical key.

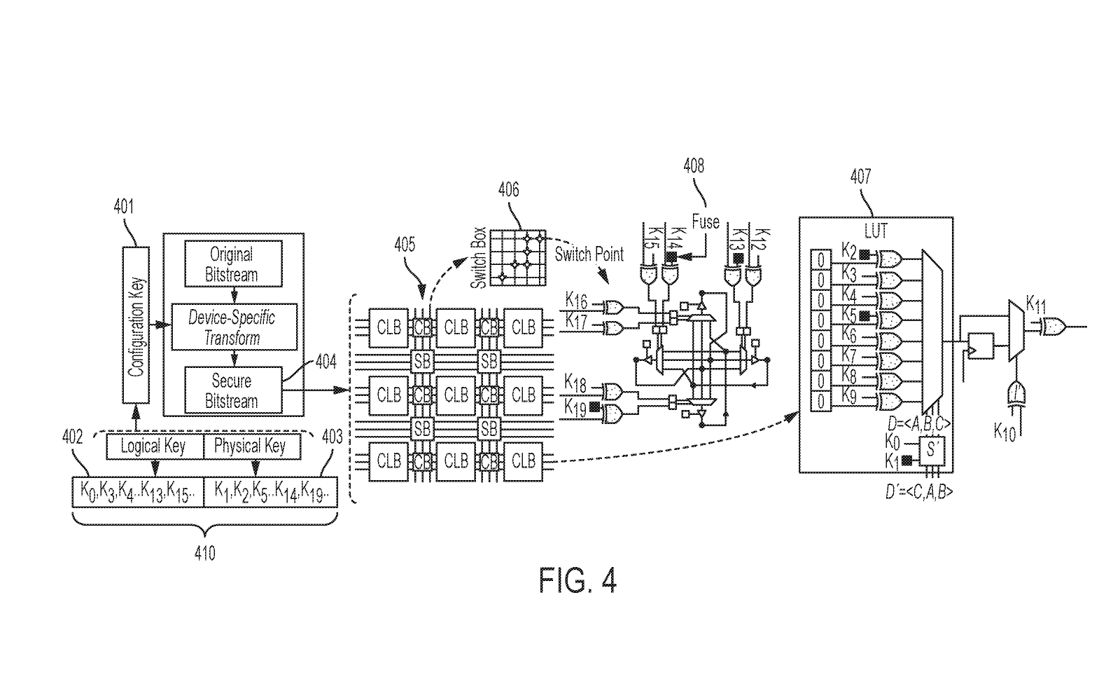

FIG. 4 is an illustrative diagram showing the mapping flow according to some embodiments. As shown in FIG. 4, a device key K_{D} 401 is generated based on two portions 402 and 403 of the identifier 410 representing the physical and logical obfuscation layer, respectively. Each portion of the identifier 410 controls some aspect of the bitstream-to-device mapping via the device key 401 to generate a secure bitstream 404. The secure bitstream 404 is mapped into the FPGA fabric 405, including programmable interconnects 406 and lookup tables (LUTs) 407. LUTs contain physical (fuse 408-based) and time-variant (logical) selective inversion logic.

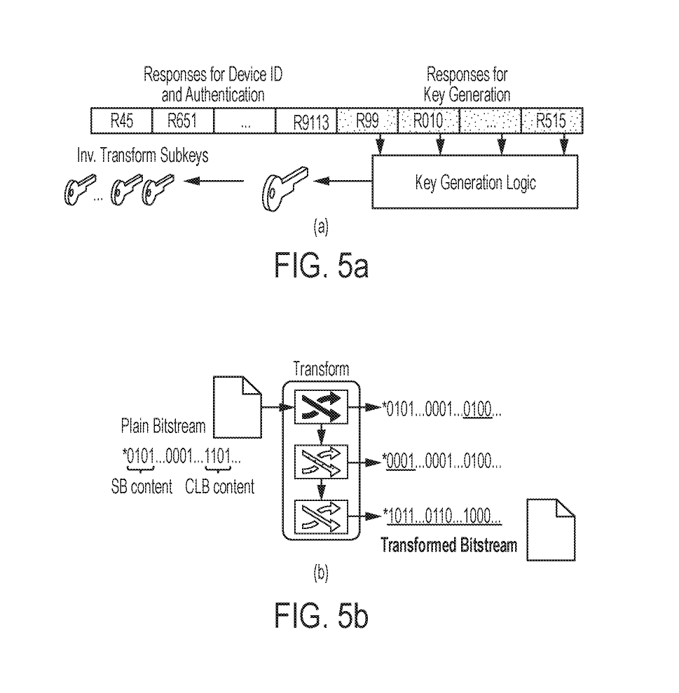

According to a non-limiting example, a multilayer transformation may be provided which operates on different portions of the bitstream in a serial fashion, such as 1) the LUT input ordering, 2) the LUT content ordering, and 3) block based transformation of the entire bitstream. FIG. 5b shows an illustrative example of a three level transformation scheme. A fourth level, which performs selective (key-based) inversion of the LUT contents, may be added after Level 2. In some embodiments, inclusion of the key-based inversion stage helps reduce the risk that functions like and with a truth table of 0001 may be used to deduce the transform key by observing the position of the “1”. In some embodiments, these modifications to the bitstream are made in addition to, and with full knowledge of, the particular physical architectural changes already made to the device.

In some embodiments, the obfuscated and node-locked bitstream based on the unique device identifier is transmitted through an external interface to the authenticated FPGA.

In some embodiments, unlike the physical layer, additional hardware blocks are provided for the logical layer to perform the inverse transform. In one non-limiting example, for a multilayer transform structure, a set of three hardware cores perform serially the transform operations in reverse order of those performed by the Vendor tool. In this example, Levels 1 and 2 are both localized; that is, there are individual hardware modules which perform the inverse transform. Further according to the example, Level 3 is distributed along every row of the FPGA fabric; however, only some of these modules actually operate on data; the others may be “dummy” units which serve to further obfuscate the nature of the transform network. In this example, a successful Level 1 inverse transform may result in a valid bitstream; however, it may not function as expected unless the proper Level 2 and 3 inverse transform keys are applied.

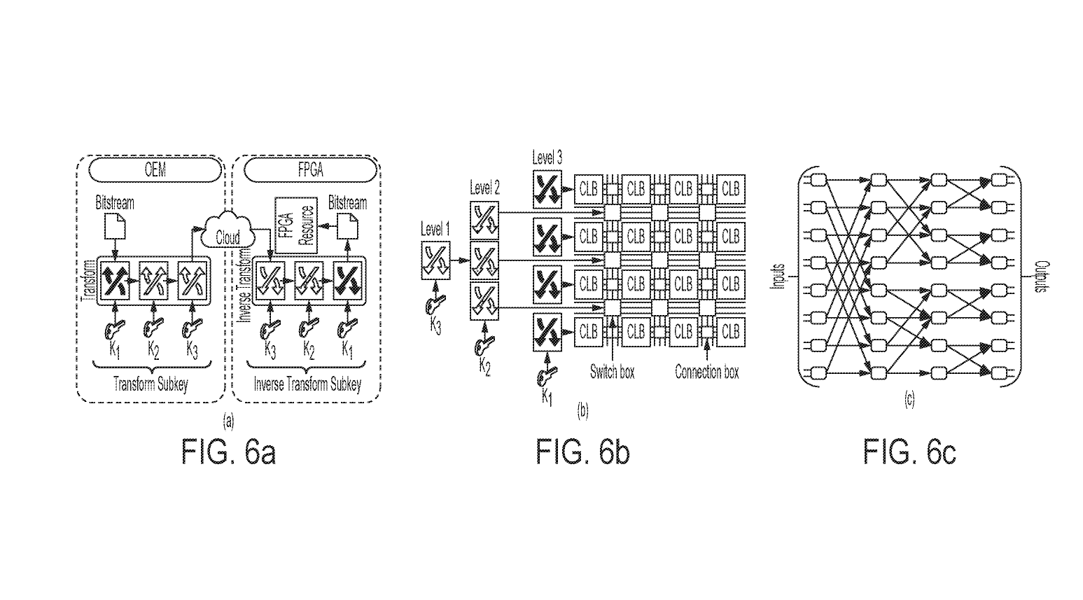

FIG. 6a shows an illustrative example of a three level transformation scheme in the embodiments discussed above. In FIG. 6a, the Vendor tool transforms the bitstream using the three device-specific keys. Level 1 reorders the LUT inputs; Level 2 permutes the LUT content; and Level 3 performs a bit-level key-based bitstream permutation. In the example in FIG. 6b, inverse-transforming occurs in reverse order using the appropriate inverse transform keys to recover the original bitstream. FIG. 6c shows an example Level 1 inverse transform network, operating on 16 bits of input, using 4 bits of key to transform data. Although three transformation levels and three inverse transform keys are shown in the example in FIG. 6a, any number of transform levels and any number of transform/inverse transform keys may be used to apply transformation to any of the FPGA resources. In some examples, a transformation level may apply selective inversion of a portion of LUT content bits based on the key, or selective inversion of a portion of LUT outputs based on the key, where the key can be physical or logical, or a combination of each.

Thus, with the combination of physical and logical architectural changes, the embodiments discussed above allow a unique bitstream-to-device mapping to be obtained. Though both physical and logical layers depend on a key, the physical changes may be accomplished using fuses, which cannot be changed at a later time. However, the logical key-based modifications may be time variant, which means that the architecture may effectively change with every reprogram cycle, making it impractical for an adversary to mount a known design attack.

FIG. 5a provides an illustrative diagram showing an embodiment of a device key management protocol. Responses from the PUF that are not retransmitted for authentication purposes may be used instead to generate the key, as shown in FIG. 5. Furthermore, the responses used to generate the keys are selected by a decoder in the generation module; as an added measure of security, select bits may be randomly disconnected from the supply circuit using a series of fuses during enrollment.

A complete bitstream generation flow according to some embodiments is shown in the illustrative diagram in FIG. 3(b). Each time the FPGA is upgraded, a different set of challenges may be issued, from which a different set of transform keys are generated. Such a moving target defense may help further secure the IP and prevent unauthorized reprogramming with previously used transform keys. Therefore, only after the device is authenticated and identified can the transformed bitstream be generated and sent to the device.

Having thus described several aspects of some embodiments of this invention, the following provides exemplary security analysis and overhead analysis of the device and method in the aforementioned embodiments comparing power, performance, and area overhead to commodity AES encryption cores.

Security Analysis

In some embodiments, a security analysis is provided for three attack scenarios, namely 1) brute force, 2) side channel attacks, and 3) destructive reverse engineering. The attacker may intend to reverse engineer the design either for monetary gain, or perform malicious modification and reprogram the device.

Brute Force Attack

A brute force attack represents the most challenging and time consuming attack on the system. Four attack stages are analyzed; for each stage, the attacker begins with incrementally more information.

### Example Case 1.1.1

The attacker has, by some means, obtained a copy of the transformed bitstream.

Result: Without knowledge of the bitstream structure (e.g. fixed header contents), the attacker cannot identify the correct inverse transform key, even for Level 1. Thus, a brute force attack cannot be properly mounted, and the IP remains secure.

### Example Case 1.1.2

The attacker has a copy of the transformed bit-stream and knows the bitstream structure (e.g. typical contents of the header).

Result: The attacker can mount a brute force attack and attempt to deduce the Level 1 transform key. In this example, a 128 bit key may operate on 16 bit blocks, each of which is permuted using 4 bits. Thus, the number of possible permutations for each of the (128/4=32) blocks is 16³²=2¹²⁸. This provides the first level of defense. Even if this is broken, Levels 2 and 3 are intact and the IF remains secure.

### Example Case 1.1.3

The attacker begins with a Level 1 inverse transformed bitstream, and intends to break Levels 2 and 3.

Result: A Level 1 inverse transformed bitstream may be mapped to an FPGA or simulated using a bitstream-to-netlist tool. For each possible combination of the LUT inputs and outputs, the attacker performs the conversion, provides the proper stimuli, and observes I/O patterns. Without detailed knowledge of the intended functionality, or a sufficiently large set of test vectors, the process cannot be automated. Even with sufficient test vectors, brute force is not feasible: in an example of a set of 4×1 LUTs with four content bits and the possibility that some of the content bits may be inverted, the LUT can take 1 of L!×I possible states, where L is the LUT size, and I is the number of possible inversions.

I is computed as Σᵣ₌₁^{L L}Cᵣ, which for L=4 gives 15 inversions; thus, each LUT can take 1 of 4!×15=360 combinations. Transforming the 4 bit LUT requires 2 bits of the key; thus, the 128 bit key operates on 64 blocks a search space of 360⁶⁴=2^{543.5}. When considering the Level 3 transform, 2 transform bits may be provided, requiring 1 key bit, giving us up to 128 Level 3 inverse transformers. Depending on the size of the FPGA, only a portion of these may be used. With all 128 inverse transformers, this yields 21²⁸ possibilities.

### Example Case 1.1.4

The attacker has obtained all three transform keys, and has applied the Level 1 and 2 inverse transformers, leaving only the Level 3 transform intact.

Result: Without the architectural knowledge of which rows in the FPGA fabric have an active transformer, the attacker cannot know to which bits the Level 3 inverse transformer should be applied. Let R represent the number of rows in the FPGA fabric, and D the number of active inverse transformers. The possible permutations is represented by ^{R}P_{D}. For a small FPGA (e.g. Xilinx XC3S50) with R=16 and D=12, we have ¹⁶P₁₂≈2^{39.7} possible inverse transform networks. On a larger FPGA, with R=512 and D=128, this would increase to ⁵¹²P₁₂₈≈2¹¹²⁷ possible networks. If D is unknown, these values represent the lower bound of attempts in a brute force attack.

Thus, in the example brute force attack scenarios discussed above, by itself, the Level 1 inverse transform presents a challenge to a brute force attacker; in the example case where the Level 1 inverse transform is compromised, Level 2, including the key-based inversion, and Level 3, including both the key-based input transform and the “dummy” inverse transformers make a brute force attack impractical.

Side Channel Attack (SCA)

Compared with brute force, a SCA is a more refined attack. Two example scenarios are presented herein in which one or more of the keys have been discovered in this manner.

### Example Case 1.2.1

The attacker uses power analysis (e.g. DPA) to discover the challenge vectors stored in NVM.

Result: Responses are generated on-the-fly using a PUF, so leaking the challenge bits is not useful without an accurate PUF model. The generation procedure is purely combinational, using no latches of flip flops, and therefore is less vulnerable to power analysis.

### Example Case 1.2.2

The attacker has discovered one or more of the CR pairs, for example through the use of wireless packet analysis.

Result: With sufficient CR pairs, the attacker may be able to refine a model of some kinds of PUFs (e.g. arbiter or ring oscillator PUF), making the choice of PUF crucial to system security. In some embodiments MECCA PUF may be a good choice because it is resistant to these attacks. In any case, very few pairs are sent each upgrade, limiting the attacker's potential knowledge of the system.

SCA attacks may be used to leak the Challenge vectors or isolate CR pairs from packet analysis. However, as discussed above in Example case 1.4 under the Brute Force Attack scenario, knowledge of the Level 3 key is insufficient to fully inverse transform the design. Thus, in the example SCA scenarios discussed above even if modeling attacks are successful, the IP remains secure.

Destructive Reverse Engineering (DRE)

DRE is an expensive and time consuming process, but it can reveal the inner workings of the device. Two example scenarios of using DRE attacks are discussed.

### Example Case 1.3.1

DRE is used to reveal the structure of the Level 3 transform network, including which rows contain deactivated inverse transformers.

Result: This reduces the number of possible bitstream permutations. However, without further analysis (e.g. successful PUF modeling), the IP remains secure.

### Example Case 1.3.2

DRE is used to reveal the PUF structure, potentially making the device vulnerable to these attacks and reducing the search space for the correct transform key.

Result: Modeling attacks have been proposed and successfully executed for certain PUFs (e.g. Arbiter PUF [Ref. 12]). Nevertheless, there is inherent uncertainty in the probabilistic approach employed by the attack models, and some PUFs have been proposed [Ref. 13, 14] which are resistant to these attacks. Even if the transform key is revealed, knowledge of the Level 3 transform network, which may demand further DRE, is desired to make use of it.

Therefore, from the above analysis of three types of example attack scenarios, it is clear that even with a combination of SCA and DRE attacks, some level of brute force is still necessary to inverse transform a single bitstream for a single device. Of all the attacks presented above, the only one with wide-ranging consequences is the discovery of the Level 3 transform network. By itself, this does not fully compromise the system; significant analysis, and some brute force, may still be required. Furthermore, the device-specific keys and CRCP disclosed in some embodiments also ensure that unauthorized reprogramming on other IoT connected devices will not be possible, since only one specific device can acquire the targeted upgrade, making malicious modification and reprogramming infeasible. This approach reduces, and perhaps entirely mitigates, the economic motivation for an attacker.

2) Overhead Analysis

In this section, the power, performance, and area overhead incurred using the bitstream security system disclosed in some embodiments are analyzed. Components are implemented in Verilog, simulated to verify functionality, and synthesized with Synopsys Design Compiler using a 90 nm cell library. Results for Area, Power, Delay, and Energy of the various modules are listed in Table 1. Results represent an FPGA with one Device Key Module (DKM), three Response Generator Modules (RGM), one Level 1 and one Level 2 Inverse transform Logic Module (DLM1 and DLM2), and 32 DLM3 modules.

TABLE 1
Synthesis results at 90 nm. “Num Inst.” is
the number of instances considered in the results.
Delay and Energy are for a 512 kB bitstream.

| Mod. | Num | Area | Area | Pow. | Delay | En. |
|---|---|---|---|---|---|---|
| Name | Inst. | (μm2) | (Gates) | (mW) | (ns) | (pJ) |
| DKM | 1 | 9398 | 827 | 1.08 | 1.38 | 1.49 |
| RGM | 1 | 145 | 34 | 0.02 | 1.18 | 0.02 |
| DLM1 | 1 | 1063 | 115 | 0.18 | 6200 | 1120 |
| DLM2 | 1 | 4273 | 406 | 0.77 | 33.0 | 25.4 |
| DLM3 | 32 | 4328 | 460 | 0.67 | 0.17 | 3.64 |
| Total | | 19207 | 1842 | 2.72 | 6236 | 1150 |

2.1) Device Key Modules

In this example, the DKM is a purely combinational circuit with no memory elements. The input selects 2 of 8 PUF-generated responses, each 64 bits in length.

2.2) Response Generator Modules (RGMs)

In this example, the RGMs are based on the MECCA PUF [Ref. 13], which uses an existing SRAM memory array to generate a response. A programmable pulse generator using a tapped inverter chain interfaces with existing SRAM peripheral logic; very little extra hardware may be needed.

2.3) Inverse Transform Logic Modules

In some embodiments, inverse-transformation may occur in three separate stages, each controlled by a separate 128 hit key. Note that timing is reported for each module independent of external factors, such as serial to parallel (or parallel to serial) conversion in and out of the modules.

2.3.1) Example with Level 1: In this example, a 16 input Banyan switch network implements the Level 1 inverse-transformation logic. Four bits of the transform key are used as inputs to each column of switches.

2.3.2) Example with Level 2: The second level inverse transforms the LUT content Like Level 1, the key determines the mapping from input to output ordering. In this example, LUT responses are defined by 4 bits; thus, the network operates on 16 inputs, each a 4 bit vector. Selective inversion of the transform bits is determined by the transform key.

2.3.3) Example with Level 3: The third level inverse transforms the LUT inputs, and inverse transformers are distributed among the rows in the FPGA fabric. An immense FPGA fabric is provided in this example with 1024 rows, and therefore 1024 transform networks (some are deactivated). All LUTs are 4×1 in this example, and thus have two select inputs.

3) Comparative Analysis

The total area, power, and latency overhead may be analyzed in the embodiments disclosed above as the sum of the respective parameters for each module. Table 2 compares the analysis results with several AES cores (from both IP vendors and literature).

TABLE 2
Comparing the Node Locked Bitstream (NLB) with
AES ASIC cores. Delay and Energy are calculated
from throughput for a 512 kB bitstream.

| Mod. | Tech | Area | Pow. | Delay | EDP |
|---|---|---|---|---|---|
| Name | (nm) | (Gates) | (mW) | (μS) | (J*s) |
| NLB | 90 | 1.8k | 2.72 | 6.2 | 1.07e−13 |
| [Ref. 15] | 180 | <3k | — | 64000 | — |
| [Ref. 16] | 130 | 3.1k | 5.62 | 33850 | 6.44e−6 |
| Tiny [Ref. 17] | 130 | <5k | — | 40960 | — |
| Std. [Ref 18] | 90 | 8.8k | — | 2800 | — |
| Std. [Ref 17] | 130 | <9.5k | — | 630 | — |

Table 2 shows that in some embodiments, even after scaling power and throughput to the 90 nm node, the Node Locked Bitstream method is faster than the area- and power-optimized crypto cores, and incurs a lower area and power overhead, making it ideal for power- and area-constrained systems. Furthermore, like the crypto cores, it offers excellent security against brute force attacks. In addition, it is more resilient to SCA and even DRE attacks.

The NLB system disclosed herein is capable of protecting FPGA bitstreams against a number of attacks, including brute force, side channel, known design attacks and destructive reverse engineering, effectively preventing IP piracy and malicious modification. Having thus described several aspects of some embodiments of this invention, it is to be appreciated that various alterations, modifications, and improvements will readily occur to those skilled in the art.

For example, the NLB concept may be extended, first by adding additional layers of security beyond those previously listed for FPGA, and by applying these concepts to the domain of software security for microcontrollers (firmware) and more complex processors (full software applications, including those compiled to machine language or interpreted code, for example Java). These extensions are attractive for a number of reasons:

Additional security makes it less likely for an attacker to successfully pirate, reverse engineer, or maliciously modify the IP by including terms which exhibit factorial growth.

It allows for the consideration of additional FPGA hardware structures, and presents opportunities to identify more cost effective modifications, providing equivalent-or-better security using the same or fewer key bits; this in turn provides an empirical means to optimize security versus area/power/delay overhead in different FPGA implementations.

The inventors have recognized that microcontrollers (and their various application domains, including automotive, communication, consumer electronics, among others) present an even larger market than FPGA, and receive firmware upgrades at least as frequently as an FPGA-based device from trusted vendors (e.g. Original Equipment Manufacturers, OEM). Ensuring the integrity of these firmware upgrades, especially those transmitted Over the Air (OTA) is essential to maintaining device security.

A discussion of microcontroller firmware security further leads to methods which can improve security for systems with more complex General Purposes Processors (GPPs), including desktop and laptop computers. Users of these systems can download software from a plethora of online sources, many of which can be counterfeit or malicious, resulting in malware which can wreak havoc on a system or leak personal information to an attacker. Controlling the sources of these applications and judiciously restricting the ability of a target architecture to execute them can help curb both the distribution of malicious software, as well as the unauthorized distribution of proprietary software, thus doubling as an alternative to software node-locking.

The following three sections describe additional embodiments providing extensions to the NLB framework discussed above for the application in (1) FPGA bitstream security. (2) microcontroller firmware security, and (3) general purpose processor security.

Extensions of NLB for FPGA

In some embodiments, FPGA security can be extended using additional permutation and selective inversion networks, operating not only on the LUT content, LUT input, and the bitstream as a whole, but on any amenable hardware structure on the FPGA. These resources include, but are not limited to, the following: configurable logic blocks (CLBs), routing/programmable interconnects, block RAM/embedded memories, DSP blocks, IO blocks and clocks/PLLs.

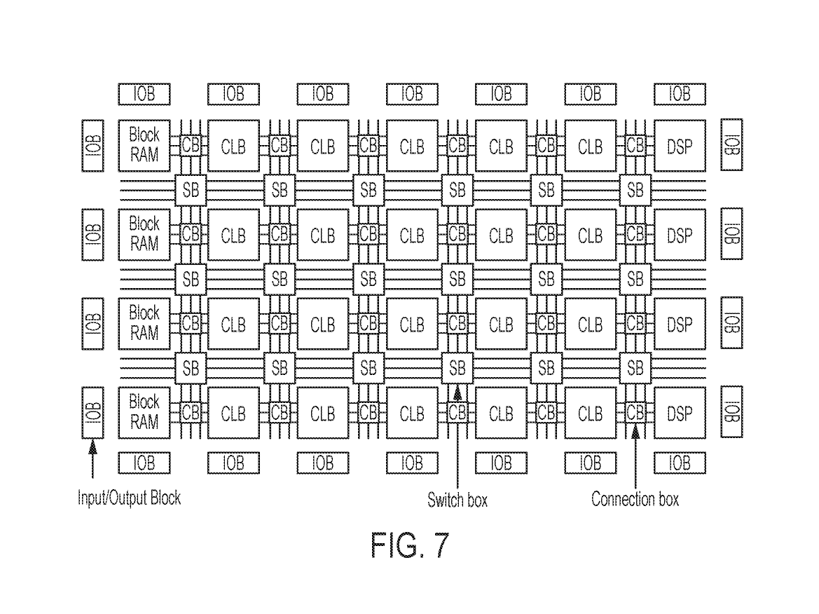

A simplified example of the FPGA architecture combining the mentioned resources is shown in FIG. 7. Tables 3, 4 and 5 summarize different aspects of implementing the obfuscation model on different resources according to some embodiments. The NLB model may be implemented on individual resources, or on multiple resources in parallel to increase the level of security.

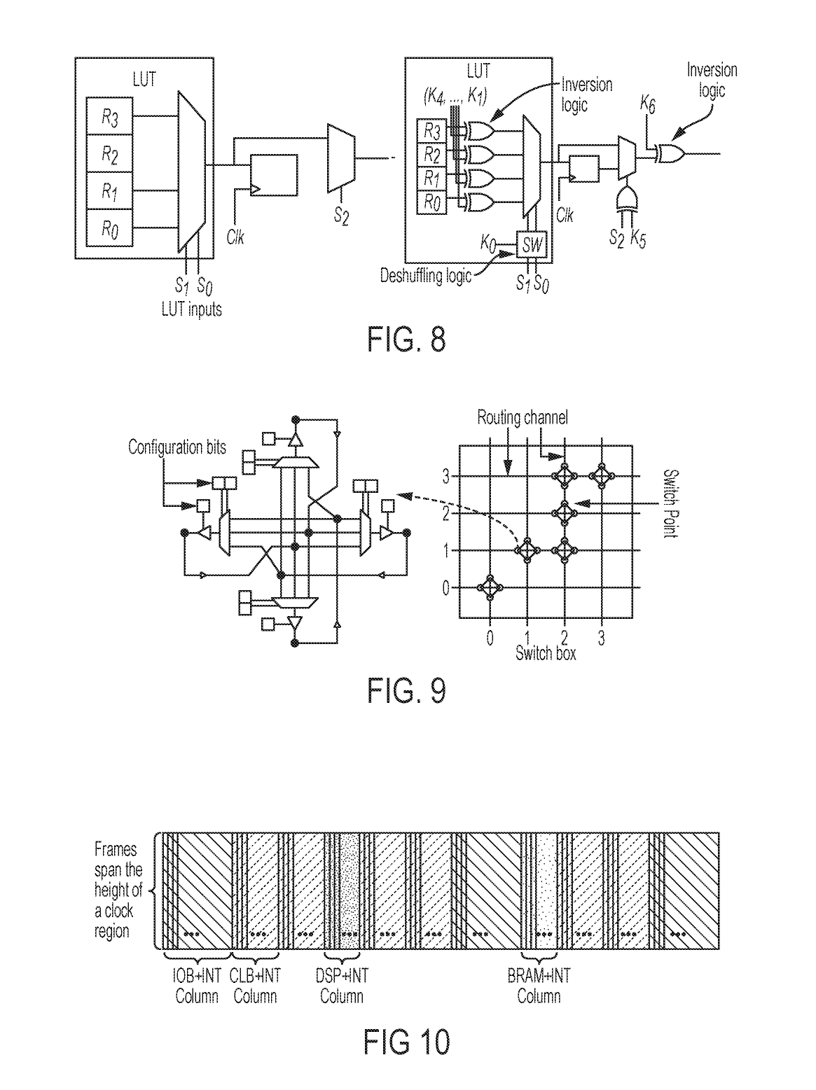

TABLE 3
Various aspects of implementing permute and selective inversion networks on CLB resources.

| | Sub- | | Architectural change required to | | |
|---|---|---|---|---|---|
| Resource | resource | Resource Description | map the IP from obfuscated bits | Required Key bits | Resultant Diversity |
| CLB | LUT | Lookup Tables (LUTs) | The actual content bits to the | Assume number of LUT | For LUT with [symbol] , |
| content | Content | contain SRAM cells | configuration bitstream will be | inputs is 1 and number | [symbol] the number of different |
| (FIG. 8) | | which [symbol] old | permuted using the compilation | of Content bit [symbol] = 2 [symbol] . | possibilities would be L [symbol] . |
| | | function responses | tool. In the FPGA, a harware | The required key to | Example: Let [symbol] = 4, |
| | | (“Current”) | block within the LUT undoes this | shuffle L bits is log₂(L). | there are 4 [symbol] (24) possible |
| | | required for the | operation. Forward and inverse | Example: for 4 input LUT | combinations. In practice, |
| | | design. | transforms are done using a key. | with 16 content the key | [symbol] = 2 [symbol] or 2 [symbol] |
| | | | | size is log₂(16) = 4. | are more common. |
| | LUT | | Certain content bits will be | To invert, one key bit is | For a certain LUT. the number |
| | Content | | inverted inside the tool based on a | required per content bit. | of content bits to be [symbol] is |
| | Selective | | Key. Symmetric inverse transform | Key size equals LUT size. | equivalent to the number of |
| | Inversion | | [symbol] recovery of original key | | logic [symbol] 's in the subkey, |
| | | | bits. | | given [symbol] r. Attackers must |
| | | | The inversion logic take the key | | search all possible values of [symbol] , |
| | | | and inverts based on [symbol] . The | | requiring Σ [symbol] ^{L}C [symbol] |
| | | | resultant bits in the SRAM cell | | Example: Let L = 4. This |
| | | | maps the original design. | | gives 1 [symbol] possible |
| | | | | | combinations. LUTs where |
| | | | | | L = 2 [symbol] or 2 [symbol] |
| | | | | | are common in [symbol] , |
| | | | | | [symbol] large search spaces. |
| | Funtion | LUT function | One hardware block performs the | Requires [symbol] = log₂(L) key | For a LUT of [symbol] inputs, |
| | Input | evaluation results | inverse transform on the function | bits to permute the inputs | there can be [symbol] possible |
| | Multiplier | from the selection of | input, resulting in correct function | for [symbol] LUT with [symbol] funtion | orderings. |
| | | certain content bits | output from the LUT. | responses. | Example: for [symbol] 4 input LUT, |
| | | being selected by a | | | an attacker [symbol] to consider |
| | | multiplexor (mux). the | | | 4 [symbol] = 24 different |
| | | mux inputs represent | | | possibilities. |
| | | function inputs. These | | | |
| | | can be selectively | | | |
| | | modified. | | | |
| CLB | FF-Mux | Content bits in LUTs | A single bit in the configuration | The selection of FF is | For each LUT, 2 different |
| content | bit | only implement | bitstream is responsible for the FF | done by a 2:1 MUX which | probability. Either the LUT goes |
| | inversion | combinational logic. | selection via MUX. The select bit | has one select bit. The | to the FF, or bypasses the FF. |
| | | To map sequential | of the MUX that [symbol] bypasses | key size is therefore 1 | |
| | | logic, Flip Flops | the FF can be [symbol] | for each [symbol] . | |
| | | (FF) are needed. A mux | | | |
| | | selects if the LUT | | | |
| | | output will be | | | |
| | | connected with the FF. | | | |
| CLB | LUT | The final LUT output | For a single LUT, one inversion | 1 Key bit required for a | For any LUT, 2 different |
| content | output | [symbol] with or without | logic is required with the output. | single output. | probabilities are present. |
| | inversion | FF) can be inverted. | Based on the key, the output will | | However, this effects other |
| | | This output [symbol] | be inverted. | | LUTs that take this output as |
| | | connect to the inputs | | | an input. Therefore the search |
| | | of multiple LUTs. | | | space increases. If the output |
| | | | | | Y is input to some other LUT; |
| | | | | | while [symbol] each possible |
| | | | | | [symbol] of the connected LUT, |
| | | | | | the adversary has to consider |
| | | | | | both Y and Y [symbol] , |
| CLB | Carry | Carry logic is | Carry logic of LUT is selected [symbol] | Only 1 Key bit is required | for each LUT the design can |
| content | logic | available inside CLBs | MUX. For 2:1 MUX the selection | per LUT. | either have or not have a [symbol] |
| | Mux bits | with each LUT for [symbol] | bit is a single [symbol] . This single | | logic based on the key bit. |
| | inversion | propagation of carry | configuration bit can be altered/ | | For N number of LUTs the |
| | | bits while [symbol] long | inverted using one inversion logic. | | chances are 2^{N} |
| | | digits. | | | |
| CLB | Inter- | [symbol] channels | To our knowledge the low level | Refer to the analysis of | Refer to the analysis of the |
| content | connect | (wires) go inside the | architecture of the interconnect | the Switch Box. | Switch Box. |
| | matrix | CLB and connect to LUTs. | matrix is not revealed by the | | |
| | inside | LUT outputs also | [symbol] . However, it should be | | |
| | CLB | connect to the input | similar to Switch [symbol] architecture | | |
| | | of adjacent LUTs of | which is known. Therefore we can | | |
| | | the same CLB or | refer to the analysis of the Switch | | |
| | | feedback to itself. Such | Box. | | |
| | | connections are done | | | |
| | | by an interconnect | | | |
| | | matrix inside the CLB. | | | |

[symbol]

indicates data missing or illegible when filed

TABLE 4
Various aspects of implementing permute and selective inversion networks on routing resources.

| | Sub- | | Architectural change required to | | |
|---|---|---|---|---|---|
| Resource | resource | Resource Description | map the IP from obfuscated bits | Required Key bits | Resultant Diversity |
| Routing | Connection | Connection boxes connect | Refer to the analysis of the Switch | Refer to the analysis | Refer to the analysis |
| resources | box | wires to and from CLBs | Box. | of the Switch Box. | of the Switch Box. |
| outside | | with the main channel | | | |
| CLB | | outside the CLB. | | | |
| (FIG. 9) | | | | | |
| | Switch | The Switch boxes connect | There are 12 configuration bits for | For a single switch | For shuffling, the |
| | Box | horizontal and vertical | each switch point. If the bits are | point with B | possible search space |
| | | routing channels. Each | shuffled, 12 bits would require a | configuration bits, | is B [symbol] for switch |
| | | Switch Box is composed | deshuffler block controlled by 4 key | N switch points in | point. |
| | | of a number of switch | bits. | a switch box, and | If r bits are inverted |
| | | points which can connect | If the bits are inverted inside the | the S different | among B, the search |
| | | certain wires. The | tool, the inverted configuration bits | switches to consider, | space is ═ Σᵣ^{B} ^{B}Cᵣ |
| | | low level design is | have to pass through the inversion | then total key bits | If both [symbol] and |
| | | shown in the [symbol] . | logic before programming the switch | required for | inversion are done, |
| | | Based on the | point. | shuffling would be, | the search space |
| | | configuration bits the | As there are multiple switch | N * S * Log₂(B). | increases to B [symbol] |
| | | switch point routes | point per switch box, and a large | For inversion. If r | Σᵣ^{B} ^{B}Cᵣ |
| | | certain wires to | number of switch boxes inside the | bits are inverted | for a single point. |
| | | different directions. | FPGA, we may obscure only a selected | the required key for | Therefore, for the |
| | | Inside the switch | number of switch boxes. It will keep | whole FPGA would | whole FPGA it is |
| | | points, SRAM cells | the key size limited and improve the | add a factor of r | N + S + B [symbol] |
| | | connect with the MUXs | difficulty of deobfuscation. | bits to the key. | Σᵣ^{B} ^{B}Cᵣ. |
| | | and tristate buffers | | | |
| | | that control the | | | |
| | | routing. These cells | | | |
| | | hold the configuration | | | |
| | | bits for the switch | | | |
| | | points. | | | |

[symbol]

indicates data missing or illegible when filed

TABLE 5
Various aspects of implementing permute and selective inversion networks on BRAM & DSP

| | | | | | |
|---|---|---|---|---|---|
| | Sub- | | Architectural change required to | Required | Resultant |
| Resource | resource | Resource Description | map the IP from obfuscated bits | Key bits | Diversity |

| | | | | |
|---|---|---|---|---|
| Block | RAM | Embedded block RAM are actually | If the initial contents of the RAM are shuffled or | Valid assumption |
| RAM | Content | kilobytes of SRAM for storing data. | inverted inside the tool, the inverse transform can | depends on details of |
| | | These RAMs are hard blocks and can | be applied internally using shuffle blocks and | the bitstream used for |
| | | be initialized in different sizes | inversion logic. However, if the content bits of | configuring Block |
| | | and operational modes which is | the SRAM are readable while the FPGA is operating, | RAMs. |
| | | defined in the bit stream. The | the adversary may be able to exploit this to | |
| | | block RAM content, the programmable | determine the shuffling pattern. Therefore, it | |
| | | interconnects, and the specifications | may be more secure to not modify the memory | |
| | | are defined by specific groups of | configuration if there is also an external memory | |
| | | bits in the bitstream frame. A | interface. | |
| | RAM Size | sample frame is shown in FIG. 10. | Operational mode and RAM size are defined while | |
| | (8 KB, | | writing the HDL code of the IP which turns into | |
| | 36 KB etc.) | | configuration bits. These bits are placed into | |
| | Data width | | specific frames. The exact frame structure which | |
| | and address | | shows exactly which bits are responsible for | |
| | width | | certain specification is not open to the public. | |
| | [symbol] made | | But as the vendors have the information, they | |
| | ( [symbol] /Single) | | can shuffle those bits and later deshuffle them | |
| | Multi-RAM | | using a centralized deshuffler inside the FPGA | |
| | Interconnect | | | |
| | Logic | | | |
| | Read/Write | | | |
| | Operation | | | |
| | Sequence | | | |
| | Specification | | | |
| | Interconnects | | | |
| DSP | Bits specifying | Dedicated hard DSPs in the FPGA are | In some of the Xilinx DSP block, various | Valid assumption |
| Blocks | the function | available. For example, [symbol] Cyclone [symbol] | combination of control inputs prepare the DSP | depends on details of |
| | to be performed | and Xilinx Virtex- [symbol] Pro devices | slice to perform certain operations such as | the bitstream used for |
| | Interconnects | contain embedded 18 × 18-bit | addition, subtraction, and multiplication. | configuring DSP |
| | | multipliers, which can be split into | Similar to block RAM the various operational | blocks. |
| | | 9 × 9 bit multipliers. Xilinx | mode and interconnects of the block that is | |
| | | Vitrex-5′ XirameDSP slices contain a | written in the HDL is defined in the bitstream | |
| | | dedicated 18 × 18-bit 2 [symbol] s complement | and the exact locations of the bits are vendor | |
| | | signed multiplier, [symbol] logic, 48-bit | specific secrets. But vendors can utilize our | |
| | | accumulator, and pipeline registers. | obfuscation model as the bitstream format | |
| | | | details for any resource are available to them. | |

| | |
|---|---|
| Clocks | Not implemented. Clocking can be easily measured through side channels, I/O direction can be directly measured, |
| and | and improper I/O can result in physical damage to the board. |
| I/O | |

[symbol]

Resultant diversity refers to the number of possible [symbol] introduced by the [symbol] . [symbol] is a practical imp [symbol] , the [symbol] of [symbol] will be significantly greater than the examples given here (due to exponential and fact [symbol] growth). Furthermore, these techniques are applied design-wide, and will therefore effect hundreds or thousands of different [symbol] depending on the size of the design. [symbol]
indicates data missing or illegible when filed

Resource Ranking:

Based on analysis from Tables 3, 4 and 5 the combination of LUT content transformation and LUT content random inversion is a preferred means of obfuscation that is very effective. This can also be an effective way to prevent bitstream tampering in some embodiments as an attacker would be unable to figure out the functionality of the bitstream by observing how the bits get stored into the SRAM cells. Only the proper key can reveal how the bits finally execute in a running FPGA. In some embodiments, transformation or inversion of switch box resources can also obfuscate the original IP to a great extent because routing resources cover a major portion of the programmable fabric. However, only altering routing bits might not be sufficient as the LUT bits can contain significant information about the IP. Therefore, an adversary might be able to partially reverse the IP even though the routing is obfuscated. A powerful solution would be randomized transformation and inversion of both routing resources and LUT contents. Obfuscation of embedded BRAM and DSP can be explored further if more information about the bitstream variations for different resource settings are available (e.g. by the FPGA vendor).

Demonstration on Test Framework:

In one embodiment, a software demonstration of the NLB techniques is provided using VPR, an academic tool which performs Verilog-to-FPGA mapping for test FPGA frameworks. The tool can take as input either a Verilog HDL circuit, or a circuit described in the Berkeley Logic Interchange Format (BLIF), as well as runtime parameters defining the key length and how the key is partitioned among the different hardware structures. In a non-limiting example, the tool outputs the following:

A “gold standard” structural Verilog file for functional simulation of the mapped design. This design uses the original primitives (e.g. 4, 5, or 6 input LUTs) to realize the circuit functionality.

A Verilog file that uses the modified primitives implementing key-based permutation and selective inversion used to realize the secure FPGA. Subkeys are passed as parameters to individual LUTs. This file can be used to functionally verify the design against the gold standard.

Two bitstream files, comprised of the LUT contents of the design. These are used to compare the similarity between the two bitstreams using the Hamming Distance metric.

A Key file stores all subkeys used in the secure design. The size of this key is used to compute the overhead in bitstream size.

A security metric based on the theoretical formulation

$$S = {\sum }_{r = 1}^{L} ( \begin{matrix}L \\ r\end{matrix} ) \times L ! ,$$

representing an empirical measure of security for LUT-only obfuscation. This enables design space exploration of tradeoffs between key length, key partition methodology, and relative security, as well as optimization of these parameters for different designs and FPGA platforms.

The output Verilog files can be simulated using ModelSim, VCS, or similar Verilog simulation application. In one embodiment, a testbench can be written to compare outputs between two modules (e.g. gold+secure (with correct key) or gold+secure (with incorrect key), demonstrating the architectural specificity of the respective bitstreams.

(2) Extensions of NLB for Microcontroller Security

A bitstream may generally refer to a stream of binary bits, such as those in a binary file used for programming the firmware of a microcontroller. For microcontrollers, the firmware-securing protocol is nearly identical to that of the FPGA bitstream security. This is because the firmware source (e.g. the device vendor) is inherently trusted, and the firmware will generally be compiled (rather than interpreted via virtual machine, for example). Just as in the FPGA Node Locking framework, the combination of key-based permutation and selective inversion may be used to provide effective architectural diversification in some embodiments. According to an aspect, the framework similarly relies on a set of challenge vectors sent by the OEM to the device, and uses the responses (generated by PUF) to identify the device. The binary is permuted individual bits are selectively inverted using multiple key-based hardware networks, affecting the instruction decoding, the program counter/control flow, functional units (e.g. barrel shifter/multiplier/floating point, etc.), and potentially any other available structures. At the hardware level, the reverse operations may be performed using the internally-generated key(s) just-in-time for execution. Therefore, in some embodiments this method incurs a small, one time overhead when the firmware loads, and a small overhead during execution in the decode stage.

(3) Extensions of NLB for CPU Security

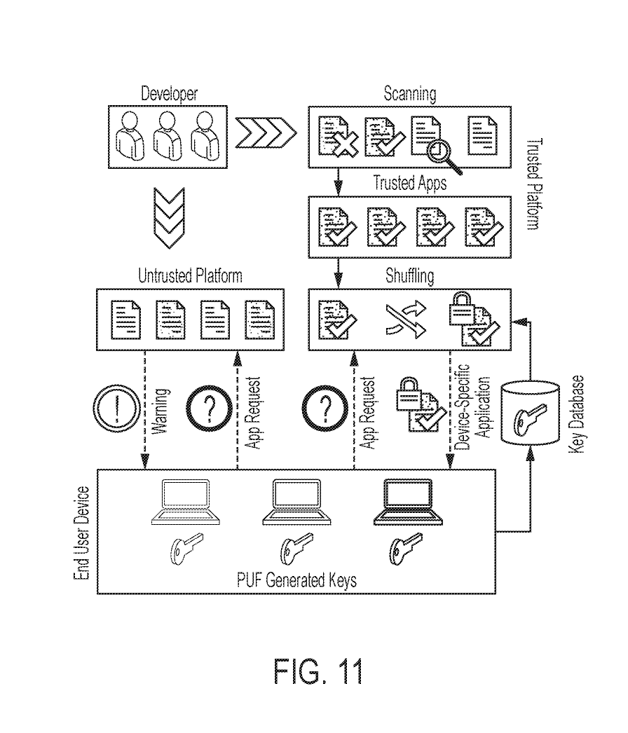

For general software application security, a different protocol may be used because the myriad software sources are not necessarily trusted, and many programming languages do not rely on compilation to machine code (e.g. Java bytecode). Therefore, in some embodiments a system may be provided whereby applications are hosted in a trusted source, which modifies the executable/bytecode/intermediate language/etc. in such a way that only one system will be capable of properly executing the code. An exemplary system flow for general application software is pictured in FIG. 11. In one embodiment, the user is only able to download programs from a set of one or more trusted servers. Applications which are hosted in this trusted space may be vetted, scanned, and verified to be safe.

In some embodiments, users wishing to download a program may simply request to download the application from the server as usual. Over a secure channel the server transmits challenge keys, which are generated locally using a hardware PUF and secured prior to transmission. Once identified, a random key is selected from the user's set of keys (stored on the cloud) and uses it to modify the application binary, which renders it unexecutable for any system except the system making the download request. The application may then be downloaded from the server and installed on the user's machine as usual. In some embodiments, the application files are stored in their modified format, so that the application cannot be transferred to another system, thus effectively node-locking the program without relying on other authentication methods (e.g. USB drive with key file, MAC address authentication, licensing server, etc.). According to an aspect, the cost introduced for the software supplier and the user is relative low compared to the level of security offered and potential for more secure node-locking of proprietary software made possible by this method. Additionally, use of the trusted cloud server and trusted developer tools may provide interoperability and backwards compatibility with existing code bases.

In some embodiments, independent software development (e.g. for hobbyist developers, students, etc.) may be facilitated by this framework. When developing an application, a user may compile the binary for their particular system using typical methods (e.g. GCC); the application binary will be transformed using a temporary key, which is generated for each application and allows that application to run on that system alone. Cloud development tools and platforms (e.g. Microsoft Azure) can potentially integrate these capabilities according to some embodiments.

### Additional Example

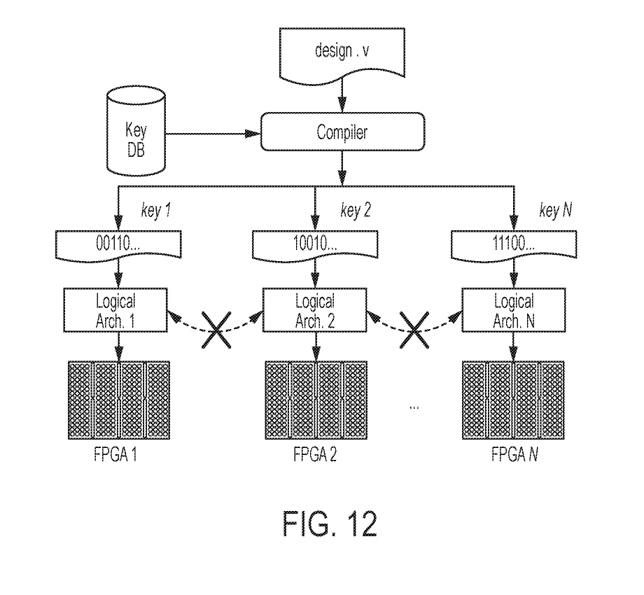

In this example, a low-overhead FPGA bitstream obfuscation solution is presented that can maintain mathematically provable robustness against major attacks. The solution exploits the identification of FPGA dark silicon, i.e., unused LUT memory already available in design mapped to FPGAs, to achieve bitstream security. It helps to drastically reduce the overhead of the obfuscation mechanism. The approach does not introduce additional complexity in design verification and incurs a low performance and negligible power penalty. In particular, the mechanism described here permits the creation of logically varying architectures for an FPGA, so that there is a unique correspondence between a bitstream and the target FPGA. FIG. 12 shows a high-level overview of this approach. Compared to existing logic obfuscation techniques, no design-time changes to the FPGA architecture or expensive on-chip public key cryptography is required. In addition to obfuscation of design functionality, our approach also enables locking a particular bitstream to a specific FPGA device, helping to prevent piracy of the valuable IP blocks incorporated in a design. Therefore, it goes well beyond standard bitstream encryption in FPGA security. Furthermore, it is targeted to the protection of FPGA bitstreams, rather than hardware metering of integrated circuits. Finally, the procedure seamlessly integrates into existing CAD tool flows for programming FPGA devices

The typical island-style FPGA architecture consists of an array of multi-input, single-output lookup tables (LUTs). Generally, LUTs of size ii can be configured to implement any function of n variables, and require 2ⁿ bits of storage for function responses. Programmable Interconnects (PIs) can be configured to connect LUTs to realize a given hardware design. Additional resources, including embedded memories, multipliers/DSP blocks, or hardened IP blocks can be reached through the PI network and used in the design.

The nature of FPGA architecture requires that sufficient resources be available for the worst case. For example, some newer FPGAs may support 6 input functions, requiring 64 bits of storage for the LUT content. However, typical designs are more likely to use 5 or fewer inputs, while less frequently utilizing all 6. Note that each unused input results in a 50% decrease in the utilization of the available content bits. This leads to an effect that resembles dark silicon in multicore processors, where only a limited amount of silicon real estate and parallel processing can be used at a given time. To make this analogy explicit, we refer to the unused space in FPGA as “FPGA dark silicon”. Note that in spite of the nomenclature the causes behind dark silicon in the two cases are different. For multicore processors, it is typically due to physical limitations or limited parallelism; for FPGAs, it is the reality of having sufficient resources available for the worst-case which may occur infrequently, if at all.

Our approach depends on the presence of FPGA dark silicon to be exploited for obfuscation needs. Consequently, we made a comprehensive evaluation of this phenomenon to identify the scope and scale of this phenomenon. Table 6 shows the result of this evaluation. Note that the evaluation uses benchmark designs of diverse scale and complexity, taken from three publicly available benchmarks, e.g., EPFL Arithmetic Benchmark Suite (http://lsi.epfl.ch/benchmarks), Opencores (http://opencores.org), and Github (http://github.org). All benchmarks were mapped to an Altera Cyclone V device [1]. The Cyclone V contains two 6-input Adaptive LUTs (ALUTs) per Adaptive Logic Module (ALM), and 10 such ALMs per Logic Array Block (LAB).

Our evaluation shows the availability of significant unused space across the diversity of benchmarks. Even for small combinational circuits (less than 2000 LUTs), roughly 50% of the LUTs mapped use 4 inputs or fewer, while 82% of the LUTs mapped use 5 inputs or fewer. The effect is more pronounced for large sequential benchmarks, where 69% of LUTs are 4 inputs or fewer, and 82% use 5 inputs or fewer.

TABLE 6
CUMULATIVE PERCENTAGE OF 1-7 INPUT LUTs

| Circuit | Cumulative % of LUTs with Inputs n | | | | | | Total |
|---|---|---|---|---|---|---|---|
| Name | ≤2 | 3 | 4 | 5 | 6 | 7 | LUTs |
| alu4 | 10.6 | 26.1 | 48.4 | 77.7 | 97.9 | 100 | 188 |
| apex2 | 11.4 | 26.0 | 52.3 | 91.0 | 99.1 | 100 | 669 |
| apex4 | 16.7 | 27.4 | 50.3 | 89.4 | 97.6 | 100 | 574 |
| ex5p | 41.0 | 42.1 | 58.7 | 84.5 | 98.4 | 100 | 373 |
| ex 1010 | 16.9 | 24.2 | 46.4 | 84.8 | 98.3 | 100 | 711 |
| misex | 14.0 | 27.7 | 46.9 | 84.0 | 97.5 | 100 | 480 |
| pdc | 16.3 | 28.5 | 51.9 | 77.7 | 98.4 | 100 | 1588 |
| seq | 16.6 | 51.9 | 51.9 | 89.1 | 99.0 | 100 | 727 |
| spla | 17.8 | 53.1 | 53.1 | 79.9 | 98.7 | 100 | 1509 |
| Avg. | 17.9 | 29.0 | 51.1 | 84.2 | 98.3 | 100 | 758 |
| div | 7.8 | 13.1 | 32.7 | 60.1 | 100 | — | 12.4 k |
| hyp | 0.9 | 28.8 | 42.6 | 64.0 | 100 | — | 45.3 k |
| log2 | 7.0 | 17.2 | 39.5 | 59.7 | 99.0 | 100 | 7894 |
| mult | 2.5 | 25.0 | 50.5 | 59.0 | 99.0 | 100 | 5553 |
| sqrt | 5.8 | 5.0 | 43.5 | 84.5 | 100 | — | 3685 |
| square | 5.6 | 55.9 | 60.2 | 74.6 | 100 | — | 4066 |
| Avg. | 4.5 | 24.2 | 44.8 | 67.0 | 99.7 | 100 | 13.1 k |
| AES | 39.7 | 64.2 | 71.0 | 100 | — | — | 4112 |
| AOR32 | 20.7 | 22.9 | 31.5 | 46.8 | 97.8 | 100 | 2299 |
| BTCM | 32.5 | 95.3 | 99.8 | 100 | 100 | — | 41.0 k |
| JPEGE | 45.2 | 37.6 | 48.4 | 67.0 | 99.4 | 100 | 5154 |
| Salsa20 | 59.9 | 57.4 | 93.8 | 93.9 | 100 | — | 2836 |
| Avg. | 39.2 | 55.5 | 69.1 | 81.5 | 99.4 | 100 | 11.1 k |

To quantify the role of dark silicon, we define a metric, the Occupancy of the FPGA, as the percentage of content bits used per LUT, divided by the total number of available bits in the LUTs which are used. We use the Cyclone V device architecture as a case study. In Eqn. 1, the number of n-input LUTs (# (LUTn)) is multiplied by the content bits used for that LUT (2ⁿ); this value is divided by the LUT capacity 2′ times the number of LUTs used in total; the variable p indicates the maximum power of the LUT, which in this case is 6. This yields the ALUT Occupancy. Next, ALM Occupancy is computed in Eqn. 2 as the average number of ALUTs per ALM; in this case, the ALM_MAX_CAP is 2. Finally, the LAB Occupancy is computed in Eqn. 3 as the average number of ALMs per LAB; LAB_MAX_CAP is 10 for the Cyclone V. Finally, the product of these three terms gives the overall occupancy (Eqn. 4), indicating the true percentage of fine-grained resource utilization at the content bit level for the given FPGA architecture.

$$\begin{matrix}{O}_{ALUT} = \frac{{\sum }_{n = 1}^{p} \# ( LUTn ) \times {2}^{n}}{\# ( LUT ) \times {2}^{p}} & ( Eqn . 1 ) \\ {O}_{ALM} = \frac{\# ( ALUT )}{ALM\_MAX \_CAP \times \# ( ALM )} & ( Eqn . 2 ) \\ {O}_{LAB} = \frac{\# ( ALM )}{LAB\_MAX \_CAP \times \# ( LAB )} & ( Eqn . 3 ) \\ {O}_{Total} = {O}_{ALUT} \times {O}_{ALM} \times {O}_{LAB} & ( Eqn . 4 )\end{matrix}$$

We computed O_{Total} for a set of 9 combinational benchmark circuits and found the average occupancy to be 26%±4%, leaving nearly ¾ of the available content bits within the used LUTs empty. This same phenomenon may extend to designs that require more resources, e.g. large arithmetic circuits for which the occupancy is slightly higher (31%±4) and the previously listed IP cores, for which the occupancy is significantly lower with higher variance (12%±8).

A. Bitstream Protection Methodology

In this section, we describe a bitstream protection methodology in accordance with an embodiment and its integration into the design flow.

A.1 Design Obfuscation

As described above, most of the LUTs used to implement a given design do not require full utilization of the available memory bits. This leaves open spaces where additional function responses can be inserted to obfuscate the true functionality of the design, which in turn makes it more difficult for an adversary to make a Targeted Malicious Modification.

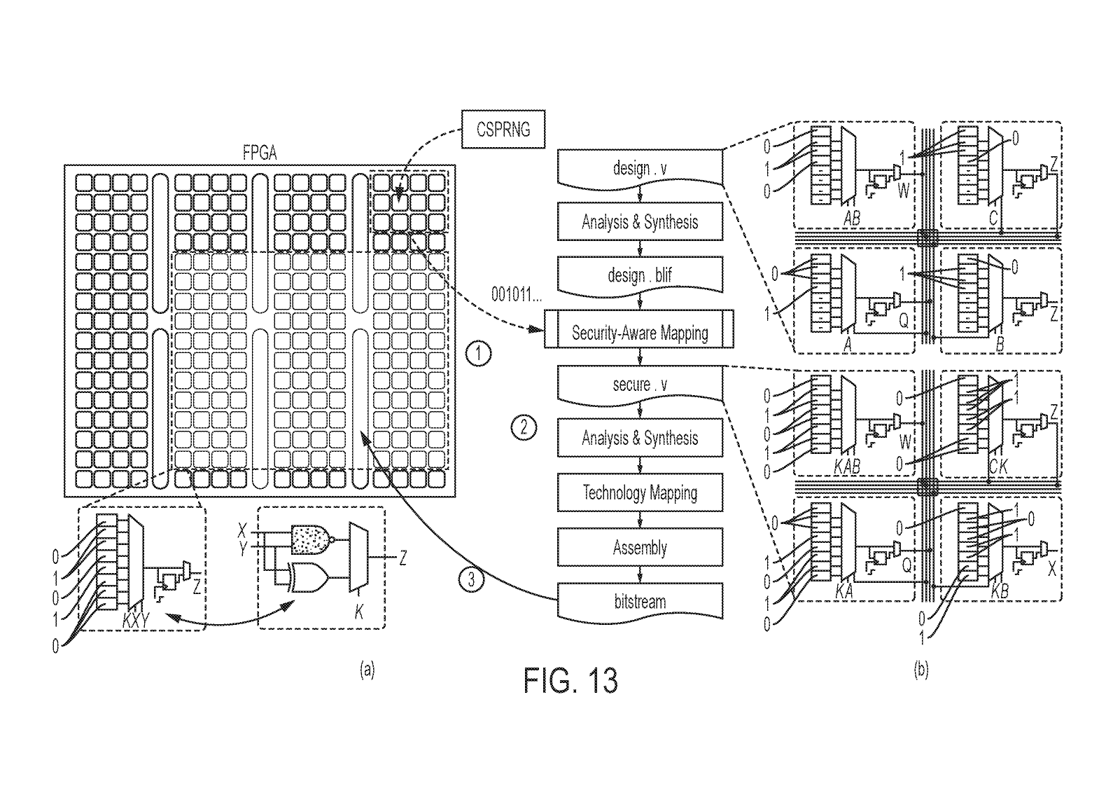

For example, consider a 3-input LUT, which contains 8 content bits, used to implement a 2 input function, Z=X∀Y. A third input K can be added at either position 1, 2, or 3, leaving the original function in either the top or bottom half of the truth table, or interleaved with the obfuscation function. An example of this is shown in the 4 LUT design of FIG. 13, as well as in Table 7. In this case, the correct output is selected when K=0; if K=1, a response from the incorrect function (Z=X [symbol] Y) is selected. However, if it is not known that this truth table is obfuscated, the function could possibly be Z=XYK [symbol] X̅YK̅ [symbol] XY̅K̅, Z=XYK [symbol] X̅Y̅K [symbol] XY̅K̅, or Z=XYK [symbol] X̅Y̅K+X̅YK̅—three functions with distinctly different responses.

TABLE 7
EXAMPLE LUTs WITH 2 PRIMARY INPUTS AND
1 KEY INPUT, THE TRUE FUNCTION IS Z = X ⊕
Y, WHICH IS ONLY SELECTED WHEN K = 0.

| X | Y | K | Z | X | K | Y | Z | K | X | Y | Z |
|---|---|---|---|---|---|---|---|---|---|---|---|
| 0 | 0 | 0 | 0 | 0 | 0 | 0 | 0 | 0 | 0 | 0 | 0 |
| 0 | 0 | 1 | 0 | 0 | 0 | 1 | 1 | 0 | 0 | 1 | 1 |
| 0 | 1 | 0 | 1 | 0 | 1 | 0 | 0 | 0 | 1 | 0 | 1 |
| 0 | 1 | 1 | 0 | 0 | 1 | 1 | 0 | 0 | 1 | 1 | 0 |
| 1 | 0 | 0 | 1 | 1 | 0 | 0 | 1 | 1 | 0 | 0 | 0 |
| 1 | 0 | 1 | 0 | 1 | 0 | 1 | 0 | 1 | 0 | 1 | 0 |
| 1 | 1 | 0 | 0 | 1 | 1 | 0 | 0 | 1 | 1 | 0 | 0 |
| 1 | 1 | 1 | 1 | 1 | 1 | 1 | 1 | 1 | 1 | 1 | 1 |

| | | |
|---|---|---|
| (a) | (b) | (c) |

The security of this approach depends on the number of LUTs that are mapped for a given design; with more LUTs obfuscated in this manner, the security increases dramatically. For real-world designs, this is not likely to be a limitation, since designs will typically implement several hundred to several thousand device resources. Further analysis of this security is presented in Section B.3.

A.2 Key Generation

The first step for the secure bitstream mapping is a low-overhead key generator, such as a nonlinear feedback shift resister (NLFSR), which is resistant to cryptanalysis. A Physical Unclonable Function can also be used; though this requires an additional enrollment stage for each device, it has the added benefit of not requiring key storage. Various PUF-based key generators have been proposed, including PUFKY, which are amenable to FPGA implementation. Furthermore, using a PUF-based key generator requires that FPGA vendor tools provide floorplanning and/or enable assignment to specific device resources for reproducibility. In general, we refer to the key generator as the system's CSPRNG, or cryptographically secure pseudorandom number generator. The specific CSPRNG used depends on the application requirements.

A.3 Initial Design Mapping

The second step is the synthesis of the HDL design into LUTs. In some embodiments, this can be performed by freely available tools such as ODIN II; it is also possible to configure commercial tools, e.g. Altera Quartus II, by including specific commands into the project settings file (*.qsf) before compilation; this generates a Berkeley Logic Interchange Format (BLIF) file with technology-mapped LUTs. It should be appreciated that the implantation of the second step is not limited to the above mentioned methods and any suitable tool and/or file format may be used.

A.4 Security-Aware Mapping

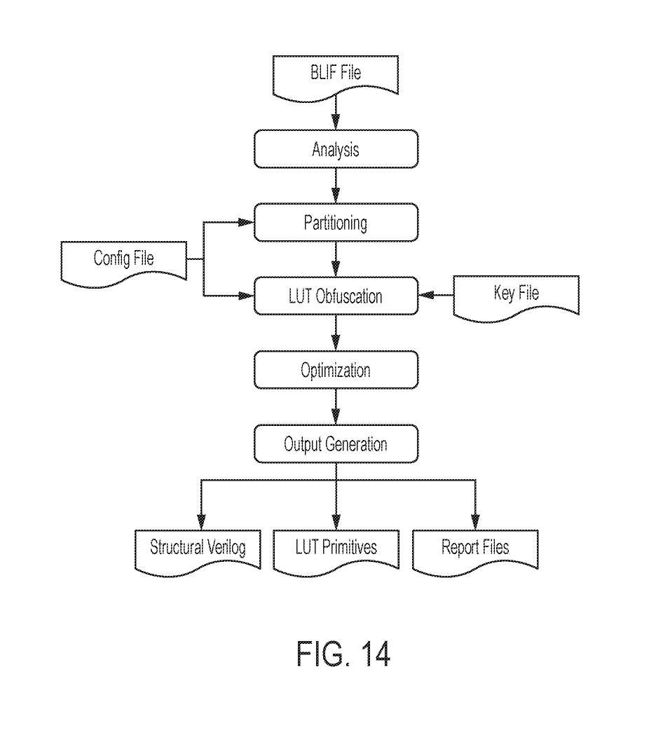

The security-aware mapping leverages FPGA dark silicon (Section A.1) for key-based design obfuscation. The software flow is shown in FIG. 14. The following is a brief description of the processing stages:

1. Analysis: Inputs to this stage include the BLIF design, as well as the maximum size of LUT supported by the target technology. The circuit is parsed, analyzed, and assembled into a hypergraph data structure. The analysis also determines the current occupancy.

2. Partitioning: Inputs to this stage include the hypergraph data structure, as well as the key length. The hypergraph is partitioned into a set of subgraphs which share common inputs/outputs using a breadth-first traversal. Nodes are marked as belonging to a particular subgraph such that those with the greatest commonality are grouped into partitions. The number of partitions is directly proportional to the size of the key.

3. Obfuscation: For a device supporting k-input LUTs, every LUT with at most (k−1)-inputs is obfuscated by implementing a second function using the unoccupied LUT content bits. One additional input is added to the LUT which corresponds to the key bit used to select the correct half of the LUT during operation. The second function can be either template-derived, such as basic logic operations (nand, nor, xor, etc.), or functions implemented in other LUTs in the same design.

4. Optimization: In this stage, individual LUTs are optimized using the Espresso Logic Minimizer. The optimized Espresso output is converted back into the internal representation. This process significantly reduces both the output file size, as well as eventual compilation time in the FPGA mapping tool.

5. Output Generation: The output file generation can take one of two formats: (a) structural Verilog, which implements the circuit as a series of assignment statements, or (b) using device-specific LUT primitive functions. The second option is preferred because using low-level primitives ensures that the design will be mapped with the specified LUTs.

The number of LUTs per partition is an especially important metric, as it has a direct impact on both the overhead and the level of security. Furthermore, the partitioning and sharing of key bits need to be done judiciously, as a random assignment can potentially dramatically increase area overhead (see Section B.2). Thus, key sharing, when paired with the LUT output generation, is intended to (a) reduce overhead, and (b) strongly suggest to the physical placement and routing algorithms used by the commercial mapping tool to group certain LUTs in a given ALM and/or LAB, and thus minimize area overhead. Ideally, this process could be integrated into a commercial tool itself to enable technology-dependent optimizations.

A.5 Communication Protocol and Usage Model

The security-aware mapping procedure creates a one-to-one association between the hardware design and a specific FPGA device, since selection of the correct LUT function responses depends on the CSPRNG output. This means that OEMs must have one unique bitstream for each key in their device database. Therefore, it is critical that the correct bitstream is used with the correct device. Modern FPGAs contain device IDs which can be used for this purpose; alternatively, if a PUF is used as the CSPRNG, the ID can be based on the PUF response. Using existing FPGA mapping software, generating a large number of bitstreams will take considerable time; however, with modifications to the CAD tools, the security-aware mapping can be done just prior to bitstream generation, so that the design does not need to be rerouted.

The initial device programming, prior to distribution in-field, may be done by a (potentially untrusted) third party. The third party is able to read the device ID, but does not require access to the key database. Similarly, device testers do not need access to the key, merely the ability to read the ID. This allows OEMs to keep the ID/key relation secret. Once the device is in field, the remote upgrade procedure differs slightly from the initial in-house programming. The typical upgrade flow is shown in FIG. 4. After finalizing the updated hardware design, it is synthesized using the security-aware mapping procedure. Target devices are queried to retrieve the FPGA ID; if the device supports encryption, the bitstream can be encrypted. Next, the bitstream is transmitted to the device, and the device reconfigures itself using its built-in reconfiguration logic.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (hut for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

### LIST OF REFERENCES

The following references are hereby incorporated by reference in their entireties:
[Ref. 1] Mehrdad Majzoobi, Farinaz Koushanfar, and Miodrag Potkonjak. FPGA-oriented Security. Introduction to Hardware Security and Trust/eds. M. Tehranipoor and C. Wang. Springer, pages 195-231, 2011.
[Ref. 2] Tim Guneysu et al. Dynamic intellectual property protection for reconfigurable devices. In ICFPT, pages 169-176. IEEE, 2007.
[Ref. 3] Ed Peterson. Developing Tamper Resistant Designs with Xilinx Virtex-6 and 7 Series FPGAs. Technical report, Xilinx, 2011.
[Ref. 4] Altera. Protecting the FPGA design from common threats. Technical report, Altera, 2009.
[Ref. 5] Sergei Skorobogatov and Christopher Woods. Breakthrough silicon scanning discovers backdoor in militarychip. Springer, 2012.
[Ref. 6] Amir Moradi et al. On the vulnerability of FPGA bitstream encryption against power analysis attacks: extracting keys from xilinx Virtcx-II FPGAs. In CCS, pages 111-124, 2011.
[Ref. 7] Siddika Berna O″rs et al. Power-analysis attacks on an FPGA—first experimental results. In CHES, pages 35-50. Springer, 2003.
[Ref. 8] Francois-Xavier Standaert et al. Power analysis attacks against FPGA implementations of the DES. In FPLA, pages 84-94. Springer, 2004.
[Ref. 9] E′ric Rannaud. From the bitstream to the netlist. In ACM/SIGDA symposium on Field programmable gate arrays, pages 264-264. ACM, 2008.
[Ref. 10] Robert McEvoy et al. Differential power analysis of HMAC based on SHA-2, and countermeasures. In Information security applications, pages 317-332. Springer, 2007.
[Ref. 11] P-Y Chen et al. Interconnection networks using shuffles. Computer, (12):55-64, 1981.
[Ref. 12] Ulrich Ruhrmair et al. PUF modeling attacks on simulated and silicon data. IEEE TIFS, 8(11):1876-1891. 2013.
[Ref. 13] Aswin Raghav Krishna et al. MECCA: a robust low-overhead PUF using embedded memory array. In CHES, pages 407-420. 2011.
[Ref. 14] A. Vijayakumar and S. Kundu. A novel modeling attack resistant PUF design based on non-linear voltage transfer characteristics. In DATE, pages 653-658, March 2015.
[Ref. 15] IP Cores. UCore-Compact Advanced Encryption Standard (AES) Core. Online, 2006.
[Ref. 16] Panu H″am″al″ainen et al. Design and implementation of low-area and low-power AES encryption hardware core. In DSD (EUROMICRO), pages 577-583. IEEE, 2006.
[Ref. 17] Helion. AES Cores. Online. 2014.
[Ref. 18] CAST. AES-C: AES Optimized Encryption/Decryption Core. Online.
[Ref. 19] R. K. Soni, “Open Source Bitstream Generation for FPGAs (Doctoral dissertation, Virginia Tech), 2013.

What is claimed is:

1. A programmable device, comprising:
an external interface;
a first circuit configured to generate an identifier;
a second circuit configured to transmit through the external interface at least one response to one or more messages received through the external interface, wherein at least a portion of the at least one response is based at least in part on the identifier;
a third circuit configured to perform a de-obfuscating function on a bitstream, wherein the de-obfuscating function is based at least in part on the identifier.

2. The programmable device of claim 1, wherein the programmable device is a field programmable gate array (FPGA).

3. The programmable device of claim 1, wherein:
at least a portion of the identifier is based on a plurality of selectively blown fuses in the programmable device.

4. The programmable device of claim 1, wherein:
at least a portion of the identifier has a value that varies over time.

5. The programmable device of claim 1, wherein:
the third circuit comprises at least one sub-circuit configured to selectively permutate the bitstream such that a position within the bitstream of at least a portion of the bitstream is changed based at least in part on the identifier.

6. The programmable device of claim 5, wherein:
the third circuit comprises a plurality of sub-circuits, connected in series, wherein each of the plurality of sub-circuits is configured to selectively permutate the bitstream such that a position within the bitstream of at least a portion of the bitstream is changed based at least in part on the identifier.

7. A method of securely programming a programmable device, the method comprising:
obtaining an identifier from the programmable device;
obfuscating a bitstream based at least in part on the identifier; and
sending the obfuscated bitstream to the programmable device.

8. The method of claim 7, wherein obtaining the identifier comprises:
sending a sequence of challenges to the programmable device;
receiving a sequence of responses to the sequence of challenges from the programmable device; and
determining, based on the sequence of responses, the identifier for the programmable device.

9. The method of claim 7, further comprising:
authenticating the programmable device based on the identifier in relation with an authorized identifier list.

10. The method of claim 9, wherein authenticating the programmable device based on the identifier in relation with an authorized identifier list comprises:
obtaining the authorized identifier list from an external source.

11. The method of claim 10, wherein obtaining the authorized identifier list from an external source comprises:
communicating with the external source using secure communications.

12. The method of claim 7, wherein obfuscating the bitstream comprises:
permutating the bitstream.

13. The method of claim 7, wherein obfuscating the bitstream comprises:
iteratively permutating the bitstream such that a position within the bitstream of at least a portion of the bitstream is changed based at least in part on the identifier.

14. The method of claim 7, wherein obfuscating the bitstream further comprises:
generating a key based on the identifier;
obfuscating the bitstream by performing a plurality of obfuscation functions, each of the plurality of obfuscation functions being based on the key.

15. The method of claim 14, wherein performing a plurality of obfuscation functions comprises:
iteratively permutating the bitstream such that a position within the bitstream of at least a portion of the bitstream is changed based at least in part on the key.

16. The method of claim 7, wherein obfuscating the bitstream based on the at least one identifier comprises:
applying a plurality of permutation levels, the plurality of permutation levels further comprising a first level, a second level and a third level, wherein:
the first level comprises permutation of portions of the bitstream that specify an input ordering of a look up table (LUT);
the second level comprises permutation of the portion of the bitstream that specifies a content of the LUT;
the third level comprises a block based permutation of the entire bitstream.

17. A method of securely operating a programmable device that receives a programming bitstream, the method comprising:
generating a pseudo-random identifier;
transmitting a sequence of responses based on the identifier in response to receiving a sequence of challenges, wherein at least a portion of the sequence of responses is based at least in part on the identifier;
de-obfuscating a received bitstream based on the identifier; and
programming programmable circuitry within the programmable device based on the de-obfuscated bitstream.

18. The method of claim 17, wherein de-obfuscating the bitstream based on the identifier comprises:
permutating the bitstream based on the identifier.

19. The method of claim 17, wherein de-obfuscating the bitstream based on the identifier comprises:
transforming the bitstream based on a plurality of fuses in the programmable device that are selectively blown.

20. The method of claim 17, wherein de-obfuscating the bitstream based on the identifier comprises:
applying a plurality of permutation levels, the plurality of permutation levels further comprising a first de-obfuscation level, a second de-obfuscation level and a third de-obfuscation level, wherein:
the first de-obfuscation level comprises permutating the bitstream on a first portion of the programmable device;
the second de-obfuscation level comprises permutating the bitstream on a second portion of the programmable device;
the third de-obfuscation level comprises permutating the bitstream on a third portion of the programmable device.
